(19) United States
(12) Patent Application Publication
(10) Pub. No.: US 2010/0176744 A1
(43) Pub. Date: Jul. 15, 2010

(54) Illumination Apparatus and Driving Method Thereof

(76) Inventors: Young Hwan Lee, Seoul (KR); Kwan Soo Jang, Seoul (KR); Chung Hyun Cho, Goyang-si (KR)

Correspondence Address: THE LAW OFFICES OF ANDREW D. FORTNEY, PH.D., P.C., 215 W FALLBROOK AVE SUITE 203, FRESNO, CA, 93711, US

(21) Appl. No.: 12/684,855

(22) Filed: Jan. 8, 2010

(30) Foreign Application Priority Data
Jan. 9, 2009 (KR) 10-2009-0001711

(51) Int. Cl. H05B 37/02; G08B 5/00

(52) U.S. Cl. 315/294; 340/815.4

(57) ABSTRACT

An illumination apparatus includes an adaptor that is detachably and electrically connectable to a socket of the illumination apparatus; a power supply unit at the adapter and that supplies power; a light emitting device driver that receives power from the power supply unit and that generates driving power; a controller that controls the light emitting device driver; an interface that communicates with the controller; and a light emitting device illumination comprising a plurality of light emitting devices that emit light according to the driving power from the light emitting device driver.

The present application claims priority under 35 U.S.C. §119(e) of Korean Patent Application No. 10-2009-0001711 (filed on Jan. 9, 2009) which is hereby incorporated by reference in its entirety.

### BACKGROUND

### Description of the Related Art

The present disclosure relates to an illumination apparatus.

At the present time, a fluorescent lamp or an incandescent lamp has been widely used as an illumination apparatus. In particular, the fluorescent lamp has low power consumption and high brightness so that it has been widely used in the office and in the home.

Meanwhile, an illumination apparatus that replaces the fluorescent lamp or the incandescent lamp has been recently developed and, representatively, an illumination apparatus using a light emitting diode (LED) has been introduced. However, in the case of the illumination apparatus using the LED, it is driven with a different voltage than the fluorescent lamp or the incandescent lamp. As a result, present power supply apparatus including conventionally installed sockets may not be useable with LED lamps.

### SUMMARY

The present disclosure provides an illumination apparatus with a new structure using an LED or OLED.

The present disclosure also provides an illumination apparatus including an LED or an OLED that can be used without replacing the power supply apparatus installed for existing fluorescent lamps, incandescent lamps, halogen lamps, etc.

The present disclosure also provides an illumination apparatus that can compatibly use various lamp sockets and power supplies by detachably installing an adapter and a lamp.

The present disclosure also provides an illumination apparatus that can adaptively control a lamp according to the type of lamp.

The present disclosure also provides an illumination apparatus that can allow a user to adjust, control and/or select the brightness and color(s) of the lamp, select a timer function for the lamp, and select, control or adjust a mood lighting system.

An illumination apparatus according to the present disclosure includes an adaptor that is detachably and electrically connectable to a socket; a power supply unit at or in the adapter and configured to supply power; a light emitting device driver that receives power from the power supply unit and that is configured to generate driving power; a controller that controls the light emitting device driver; an interface that communicates with the controller; and a light emitting device illumination unit comprising a plurality of light emitting devices that emit light according to the driving power from the light emitting device driver.

A method of driving an illumination apparatus according to the present disclosure includes converting power into driving power in an adapter; emitting light from a light emitting device illumination unit, which is detachably and electrically connected to the adapter and that includes one or more light emitting devices, according to the driving power; inputting a control command through an interface that is connected to the adapter; and controlling the light emitting device illumination unit according to the control command.

### BRIEF DESCRIPTION OF THE DRAWINGS

FIG. 1 is a diagram for explaining an illumination apparatus according to one or more embodiments;

FIG. 2 is a perspective view of the illumination apparatus according to the embodiment(s);

FIG. 3 is a block diagram for explaining an exemplary configuration of an illumination apparatus according to the embodiment(s);

FIG. 4 is a diagram showing an exemplary surge voltage absorber in the illumination apparatus according to the embodiment(s);

FIG. 5 is a diagram showing an exemplary AC-DC converter and a regulator in the illumination apparatus according to the embodiment(s);

FIG. 6 is a diagram showing an exemplary light emitting device driver and light emitting device unit in the illumination apparatus according to the embodiment(s);

FIG. 7 is a diagram showing the light emitting device unit and an exemplary ramp information generator in the illumination apparatus according to the embodiment(s);

FIG. 8 is a diagram for explaining an exemplary illumination apparatus according to one or more alternative embodiments;

FIG. 9 is a cross-sectional view of the illumination apparatus according to the alternative embodiment(s); and

FIG. 10 is a block diagram for explaining an exemplary configuration of the illumination apparatus according to the alternative embodiment(s).

### DETAILED DESCRIPTION OF THE EMBODIMENTS

In the drawings, the thickness or size of each layer is exaggerated, omitted or schematically illustrated for the convenience and clarity of explanation. Also, the size of each constituent does not completely reflect its actual size.

Hereinafter, an illumination apparatus according to embodiments will be described with reference to the accompanying drawings.

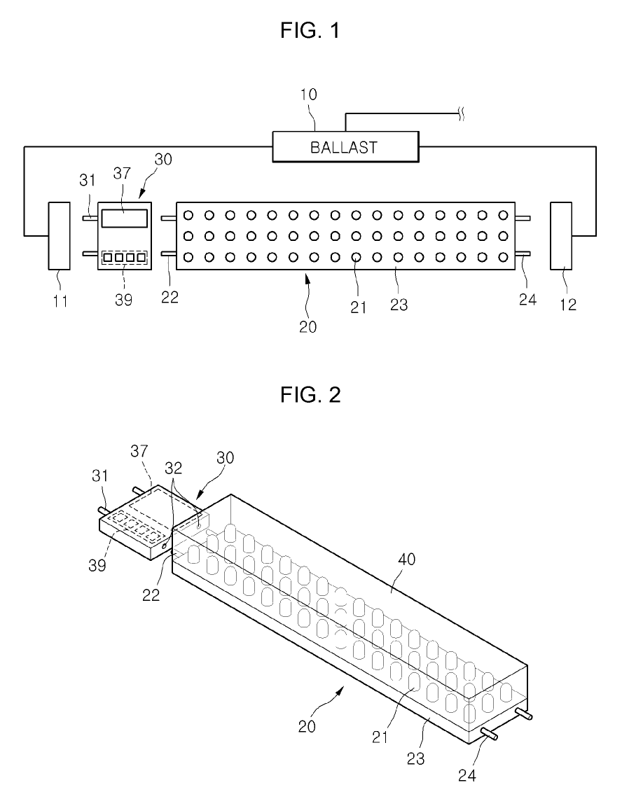

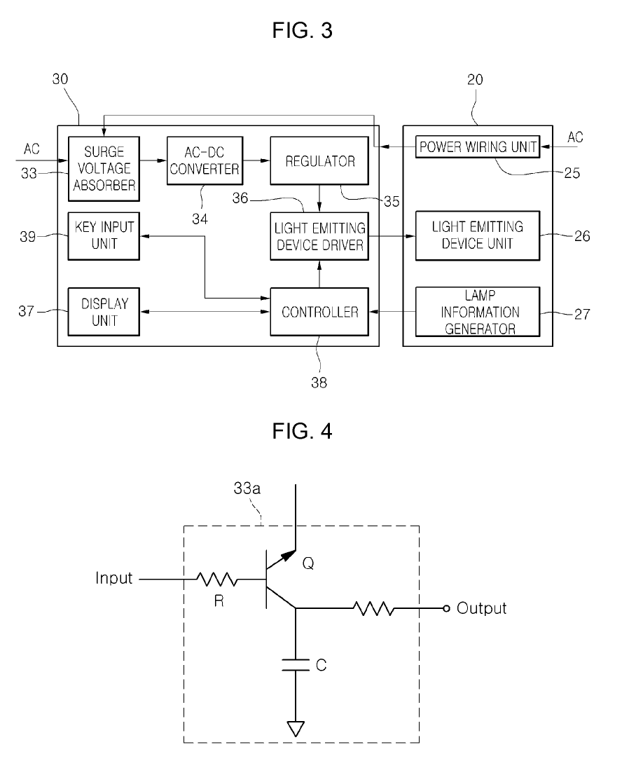

FIG. 1 is a diagram for explaining an illumination apparatus according to an exemplary embodiment, and FIG. 2 is a perspective view of the illumination apparatus according to the exemplary embodiment. FIG. 3 is a block diagram for explaining an exemplary configuration of the illumination apparatus according to FIGS. 1-2.

Referring first to FIGS. 1 and 2, an exemplary illumination apparatus includes a lamp comprising a light emitting device illumination unit 20 and an adapter 30 that drives the lamp. In the light emitting device illumination unit 20, a plurality of light emitting devices 21 (e.g., LEDs) are installed on a substrate 23. A connector 22 is electrically connected to the adapter 30 on one side or end of the substrate 23, and a second power supply terminal 24 is at the other side or end of the substrate 23. Further, a cover 40 for protecting the light emitting devices 21 may be further installed on the substrate 23.

One side or end of the adaptor 30 includes a connector groove 32 (e.g., holes or receptacles) into which the connector 22 is inserted, such that the adaptor 30 can be electrically and detachably connected to the light emitting device illumination unit 20. The other side or end of the adaptor 30 includes a first power supply terminal 31.

The illumination apparatus according to FIGS. 1-2 can replace an existing fluorescent lamp. The illumination apparatus according to FIGS. 1-2 may be installed in first and second sockets 11 and 12, in which the existing fluorescent lamp is installed, by connecting the light emitting device illumination unit 20 and the adaptor 30. Therefore, the illumination apparatus according to FIGS. 1-2 including the light emitting devices 21 (e.g., an LED or an OLED), can be installed without replacing a power supply apparatus or the first and second sockets 11 and 12 in which the existing fluorescent lamp is installed.

Currently, the power supply apparatus for installing most fluorescent lamps includes the first and second sockets 11 and 12, which provide power to a fluorescent lamp. The first and second sockets 11 and 12 are supplied with power through a ballast 10. Therefore, the illumination apparatus according to FIGS. 1-2 can be supported on or installed in the first and second sockets 11 and 12 and be electrically connected thereto by inserting a first power supply terminal 31 formed in the adaptor 30 and a second power supply terminal 24 formed in the light emitting device illumination unit 20 into the first and second sockets 11 and 12.

Power supplied to the first socket 11 is directly supplied to the adaptor 30, and power supplied to the second socket 12 is supplied to the adaptor 30 through the substrate 23 of the light emitting device illumination unit 20. The adaptor 30 receives power supplied from the first socket 11 and the second socket 12 to drive the light emitting device illumination unit 20. Alternatively, the light emitting device illumination unit 20 can be driven only by power supplied from the first socket 11 or the second socket 12.

Meanwhile, since the light emitting device illumination unit 20 and the adapter 30 are detachably installed, when defects occur in the light emitting device illumination unit 20 or the adapter 30, one can replace only the light emitting device illumination unit 20 or the adapter 30 where the defects occur. As a result, the illumination device of FIGS. 1-2 may have a low maintenance cost.

In addition, the illumination apparatus according to FIGS. 1-2 can provide direct illumination of a variety of ambients by replacing only the light emitting device illumination unit 20, since the light emitting device illumination unit 20 and the adaptor 30 are detachably installed. Furthermore, the adaptor 30 in the illumination apparatus according to FIGS. 1-2 can recognize the type of the light emitting device illumination unit 20 and thus, adaptively control the light emitting device illumination unit 20. Therefore, the illumination apparatus according to FIGS. 1-2 can freely select the light emitting device illumination unit 20, which may have various models manufactured by various manufacturers.

Moreover, in the illumination apparatus according to FIGS. 1-2, the adaptor 30 includes a display unit 37 and a key input unit 39 so that a user can control the operation of the light emitting device illumination unit 20 through the key input unit 39. Therefore, it has an advantage that the user can directly set and control the operation of the light emitting device illumination unit 20.

In the light emitting device illumination unit 20, the plurality of light emitting devices 21 are arranged on the substrate 23. Each light emitting device 21 may be an LED or an OLED. The plurality of light emitting devices 21 may emits red, blue, green and/or white light, for example.

The substrate 23 may include wiring for supplying power from the adaptor 30 to the light emitting device 21, and wiring for supplying power to the adaptor 30 from the second socket 12. For example, the substrate 23 may include a printed circuit board.

In addition, a reflective coating layer (not shown) may be formed on the surface of the substrate 23, making it possible to increase efficiency of light emitted from the light emitting devices 21. The reflective coating layer may comprise a reflective metal such as silver (Ag) or aluminum (Al).

The cover 40 may comprise a transparent plastic material, which may have one or more colors therein such as red, green, blue, etc. In addition, the cover may be made of a translucent material and in this case, it may also provide an illumination with a soft atmosphere.

Further, the exemplary adaptor 30 includes a display unit 37 and a key input unit 39 such that the user can directly control the light emitting device illumination unit 20.

Referring to FIG. 3, in the illumination apparatus according to FIGS. 1-2, the adaptor 30 may include a surge voltage absorber 33, an AC-DC converter 34, a regulator 35, a light emitting device driver 36, a controller 38, a key input unit 39, and a display unit 37. The light emitting device illumination unit 20 may further include a power wiring unit 25, a light emitting device unit 26, and a lamp information generator 27.

In more detail, a power supply unit that supplies power in the adaptor 30 may include the surge voltage absorber 33, the AC-DC converter 34, and the regulator 35. When a surge voltage for lighting a fluorescent lamp is applied from the ballast 10, the surge voltage absorber 33 absorbs the surge voltage. For example, as shown in FIG. 4, the surge voltage absorber may include a surge voltage absorbing circuit 33a.

The surge voltage absorber 33 receives an AC power that is provided from the first socket 11 and an AC power that is supplied from the second socket 12 through the power wiring unit 25 of the light emitting device illumination unit 20.

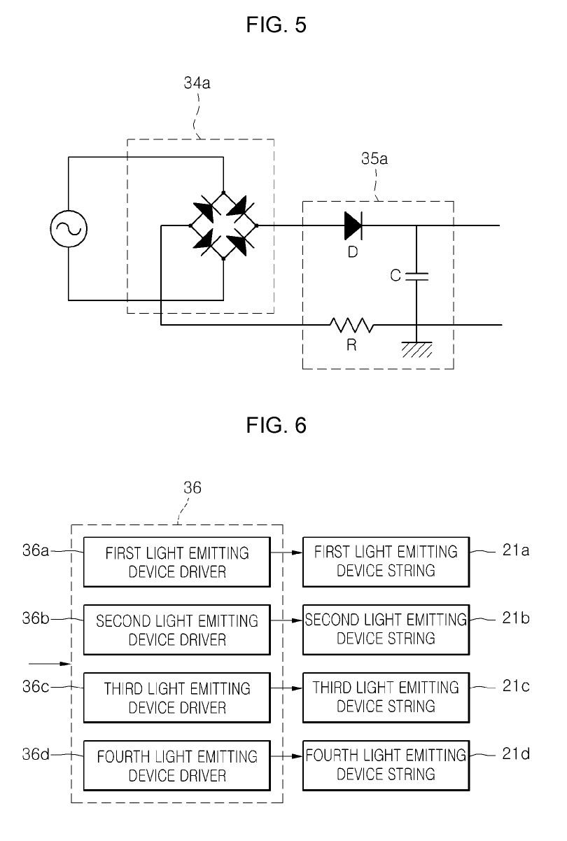

The AC-DC converter 34 converts the AC power supplied through the first and second sockets 11 and 12 into DC power, and the regulator 35 can output the DC power output from the AC-DC converter 34 at a predetermined DC voltage. For example, as shown in FIG. 5, the AC-DC converter 34 and the regulator 35 may include a bridge rectifying circuit 34a and a smoothing circuit 35a.

As described above, the power supply unit of the adaptor 30 receives the AC power from the first socket 11 and the second socket 12 and converts the AC power into DC power. The light emitting device driver 36 outputs the DC voltage supplied from the regulator 35 as a driving voltage (e.g., one or more driving pulses) suitable to drive the plurality of light emitting devices 21. For example, as shown in FIG. 6, the light emitting device driver 36 may include a first light emitting device driver 36a, a second light emitting device driver 36b, a third light emitting device driver 36c, and a fourth light emitting device driver 36d, respectively driving a first light emitting device string 21a, a second light emitting device string 21b, a third light emitting device string 21c, and a fourth light emitting device string 21d in the light emitting device unit 26 of the light emitting device illumination unit 20. For example, the first light emitting device string 21a may be in series and may emit red light, the second light emitting device string 21b may be in series and may emit green light, the third light emitting device string 21c in series and may emit blue light, and the fourth light emitting device string 21d may be in series and may emit white light.

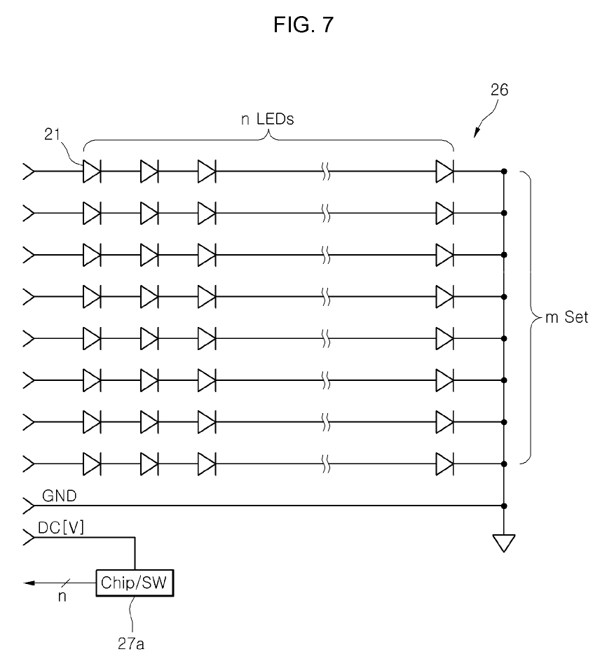

For example, as shown in FIG. 7, the light emitting device unit 26 may include a plurality of light emitting devices 21, formed as a plurality of light emitting device strings (see also light emitting device strings 21a-21d in FIG. 6). For example, FIG. 7 shows m LED strings to which n LEDs are connected in series, wherein m and n are each independently an integer of at least 2. Alternatively, each of the light emitting devices 21 in a given string may be connected in parallel between an electrical input and an electrical output of the string.

Referring to FIG. 6, the light emitting device driver 36 controls the first light emitting device driver 36a, the second light emitting device driver 36b, the third light emitting device driver 36c, and the fourth light emitting device driver 36d to control the length, power, on-off interval, etc., of the driving pulse applied to the first light emitting device string 21a, the second light emitting device string 21b, the third light emitting device string 21c, and the fourth light emitting device string 21d, thereby enabling light emitting device illumination unit 20 to emit light having various colors, intensities, patterns, etc. For example, when the driving pulse is applied to only the first light emitting device string 21a by driving only the first light emitting device driver 36a, the light emitting device illumination unit 20 can emit light of a single color (e.g., red light). In addition, when the driving pulse is applied to only the fourth light emitting device string 21d by driving only the fourth light emitting device driver 36d, the light emitting device illumination unit 20 can emit light of a different color (e.g., white light). Moreover, when the first through fourth light emitting device drivers 36a-36d simultaneously apply a driving pulse to the first through fourth light emitting device strings 21a-21d, respectively, the light emitting device illumination unit 20 can emit more white light (e.g., at a higher intensity than using the white light emitting device string alone).

Referring to FIG. 3, the controller 38 controls the first light emitting device driver 36a, the second light emitting device driver 36b, the third light emitting device driver 36c, and the fourth light emitting device driver 36d to drive the first light emitting device string 21a, the second light emitting device string 21b, the third light emitting device string 21c, and the fourth light emitting device string 21d, respectively. For example, the controller 38 provides different driving pulse information to the first light emitting device driver 36a, the second light emitting device driver 36b, the third light emitting device driver 36c, and the fourth light emitting device driver 36d, thereby making it possible to control the color, brightness, saturation, flickering (e.g., on-off cycles), etc., of light emitted from the plurality of light emitting devices 21.

Meanwhile, the exemplary light emitting device illumination unit 20 includes a lamp information generator 27. The lamp information generator 27 provides information regarding the components on the light emitting device illumination unit 20 to the controller 38 in the adaptor 30. The lamp information generator 27 may provide the information to the controller 39 by an electrical and/or mechanical method. FIG. 7 shows a chip 27a in which software (SW) including the information regarding the components on the light emitting device illumination unit 20 (and/or regarding the light emitting device illumination unit 20 itself) is provided. The lamp information on the light emitting device illumination unit 20 may include, for example, at least one of the size information of the substrate 23, the type and number of the light emitting devices 21 installed on the substrate 23, the brightness and color information of light emitted from the light emitting device illumination unit 20 (or any of the individual light emitting devices 21), and power information (e.g., including the voltage and/or current suitable to drive the light emitting device illumination unit 20, any of the individual strings 21a-21d [FIG. 6], or any of the individual light emitting devices 21).

When the lamp information generator 27 (FIG. 3) is provided in a chip 27a form as shown in FIG. 7, the lamp information generator 27 receives a voltage (DC) from the adaptor 30 and supplies the lamp information to the controller 38. The controller 38 receives the lamp information, thereby making it possible to adaptively drive the light emitting device illumination unit 20 according to the lamp information. For example, the controller 38 may supply the power information (e.g., relating to the voltage and current suitable for the light emitting device illumination unit 20) to the light emitting device drivers 36a-36d (FIG. 6). In another example, the controller 38 (FIG. 3) may supply a control signal to the light emitting device drivers 36 suitable to cause the light emitting device unit 26 emit the desired brightness and color based on the brightness and color information of the light emitted from the light emitting device illumination unit 20.

The key input unit 39 and the display unit 37 provides an interface that enables the user to directly control the light emitting device illumination unit 20. The user can operate the input units (e.g., buttons, knobs, sliding control units, keys, touchpads, etc.) of the key input unit 39 to control the brightness and color of light emitted from the light emitting device illumination unit 20. Also, using the key input unit 39, the user can set a timer function that turns the light emitting device illumination unit 20 on and/or off after a predetermined time and/or select the operational mode of the light emitting device illumination unit 20.

The display unit 37 displays a key input state, a current setting state, a selectable menu, etc., to the user, so that the user can easily control the light emitting device illumination unit 20. For example, the user can input a desired brightness setting using a brightness control button, making it possible to increase or reduce the brightness of light emitted from the light emitting device illumination unit 20. Moreover, the user can input a desired illumination color using the color control button, to change the light emitted from the light emitting device illumination unit 20 into light having a different color. Further, the user can input predetermined on and off times for the light emitting device illumination unit 20 using a timer function button, such that the light emitting device illumination unit 20 can be turned on and/or turned off at specific times. Even further, the user can input a desired operational setting using an operational mode button, such that light emitted from the light emitting device illumination unit 20 has one or more predetermined specific color and brightness values (which can change with time), making it possible to control the light emitted from the light emitting device illumination unit 20 and provide certain illumination-based effects (e.g., mood lighting, strobe lighting, color and/or intensity patterns that change over time, etc.). Therefore, the user can transmit control commands to the controller 38 through the key input unit 39 and the display unit 37, making it possible to control the light emitting device illumination unit 20.

For example, the user can control emission light of a specific color from the light emitting device illumination unit 20 using the key input unit 39, and the controller 38 can selectively drive the first light emitting device driver 36a, the second light emitting device driver 36b, the third light emitting device driver 36c, and the fourth light emitting device driver 36d according to the signal input from the key input unit 39.

In addition, the user can turn on or off the light emitting device illumination unit 20 using the key input unit 39 at a predetermined time (e.g., at 6:00 PM) or after a predetermined amount of time elapses (e.g., after 3 hours). In other words, the controller 38 can control the light emitting device driver 36 according to the change in time by inputting a timer function.

As described above, the illumination apparatus according to the embodiment(s) of FIGS. 1-2 can be used in existing fluorescent lamp sockets and power supply apparatuses configured to supply AC power because of the adaptor 30 (which may include a surge voltage absorber 33, an AC-DC converter 34, a regulator 35, and one or more light emitting device drivers 36). In other words, as shown in FIG. 1, the power supply apparatus for the fluorescent lamp includes a ballast 10 that converts commercial AC power into a high frequency current (e.g., having a frequency of 20 to 50 kHz), and first and second sockets 11 and 12 that are connected to the ballast 10. Since only the high frequency AC current is supplied through the first and second sockets 11 and 12, the light emitting device illumination unit 20 cannot be directly installed on the existing power supply apparatus. However, the illumination apparatus includes an adapter 30, making it possible to use the light emitting device illumination unit 20 using the conventional power supply apparatus as it is.

Moreover, the illumination apparatus can obtain information relating to the light emitting device illumination unit 20 in the adaptor 30, making it possible to adaptively control the light emitting device illumination unit 20 according to the characteristics of the light emitting device illumination unit 20 that is connected to the adaptor 30. Further, the illumination apparatus may include a display unit 37 and a key input unit 39, so that the user can directly control the light emitting device illumination unit 20.

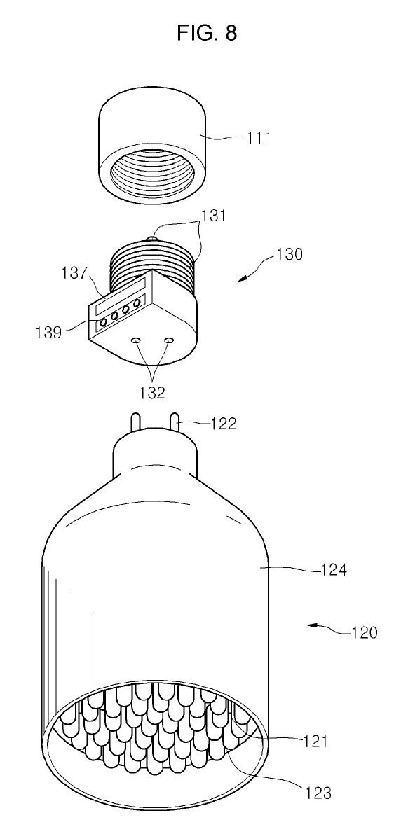

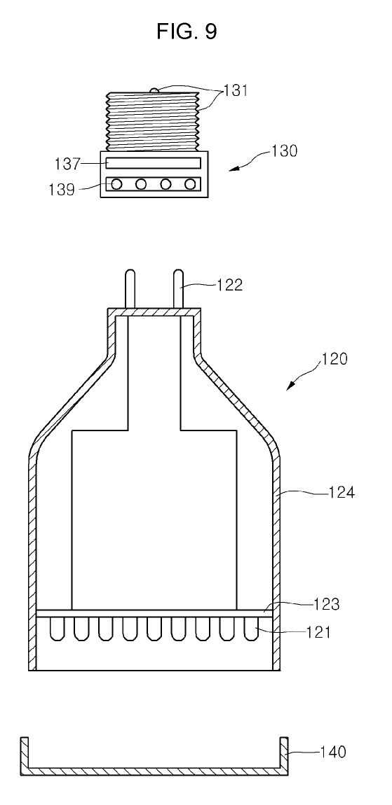

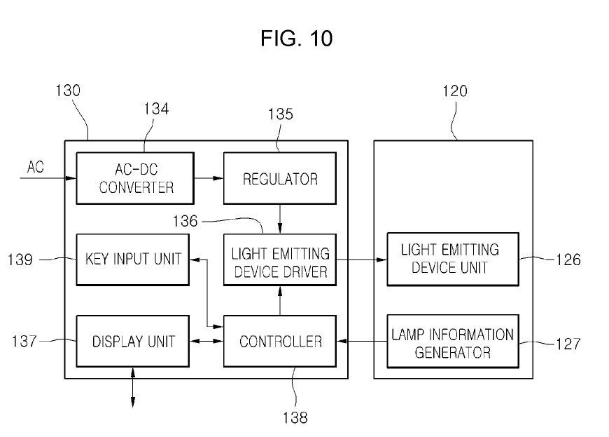

FIG. 8 is a diagram for explaining a second exemplary illumination apparatus, and FIG. 9 is a cross-sectional view of the exemplary illumination apparatus according to FIG. 8. FIG. 10 is a block diagram for explaining an exemplary configuration of the illumination apparatus according to FIGS. 8-9.

The exemplary illumination apparatus according to FIGS. 8-10 can be installed in an incandescent lamp socket or a halogen lamp socket, and in describing the illumination apparatus according to FIGS. 8-10, repetitive description from the above description of FIGS. 1-7 will be omitted.

Referring to FIGS. 8 and 9, the exemplary illumination apparatus includes an adaptor 130 that can be connected to a socket 111 for an incandescent lamp, a halogen lamp, etc., and a light emitting device illumination unit 120 that is detachably connectable to the adaptor 130.

The adaptor 130 includes spiral protrusions matched for rotatable insertion into the socket 111, a terminal 131 that is electrically connectable to the socket 111, and a connector groove 132 (e.g., holes or a socket) adapted for electrical connection to the light emitting device illumination unit 120.

The light emitting device illumination unit 120 includes a connector 122 that is inserted into the connector groove 132 to be electrically connected thereto, a housing 124 on which the connector 122 is installed and/or from which the connector 122 extends, and a substrate 123 that is connected to or fitted within the housing 124. A plurality of light emitting devices 121 are installed on, affixed to or mounted on the substrate 123. In addition, in order to protect the plurality of light emitting devices 121, the light emitting device illumination unit 120 may further include a cover 140 that is connected or (detachably) attached to the housing 124.

The substrate 123 may be a printed circuit board (PCB) on which a circuit pattern for providing power to the light emitting devices 121 is formed. In addition, the substrate 123 may further include wiring for providing power to the light emitting devices 21. The substrate 123 (or the circuit pattern and wiring thereon) is electrically connected to the connector 122.

In addition, a reflective coating layer (not shown) may be formed on the surface of the substrate 123, making it possible to increase the efficiency of light emitted from the light emitting devices 121. The reflective coating layer may comprise silver (Ag) or aluminum (Al), which may be evaporated or sputtered onto the substrate 123.

In the exemplary embodiment shown in FIGS. 8-9, the substrate 123 has a plate-type shape and is installed inside the housing 124. Therefore, when the cover 140 is connected to the housing 124, the substrate 123 and the light emitting devices 121 installed on the substrate 123 are surrounded by the housing 124 and the cover 140.

The light emitting devices 121 may comprise a plurality of LEDs or OLEDs. For example, each light emitting device 121 may independently be an LED or an OLED that emits red, blue, green or white light. Alternatively, the light emitting device 121 can emit yellow, orange, violet, purple or ultraviolet light.

The cover 140 may comprise and/or be made of a transparent plastic material. The plastic may have various colors such as red, green, blue, etc., if desired and/or necessary. In addition, the cover may comprise and/or be made of a translucent material, and in this case, it may also provide a kind of so-called “soft” illumination.

The illumination apparatus according to FIGS. 8-9 may be installed in the existing incandescent lamp or halogen lamp socket 111 by connecting the light emitting device illumination unit 120 and the adaptor 130.

In addition, in the illumination apparatus according to FIGS. 8-9, the adaptor 130 converts the AC power supplied to the existing incandescent lamp or halogen lamp into DC power, thereby making it possible to drive the light emitting device(s) 121. Therefore, the illumination apparatus can use LEDs or OLEDs without replacing the existing incandescent lamp or halogen lamp power supply apparatus and socket 111.

In particular, since the light emitting device illumination unit 120 and the adapter 130 are detachably connected, when defects in the light emitting device illumination unit 120 or the adapter 130 arise, only the defective light emitting device illumination unit 120 or adapter 130 needs to be replaced, resulting in relatively low maintenance costs.

In addition, the illumination apparatus according to FIGS. 8-9 has an advantage that can direct a variety of illumination types by replacing only the light emitting device illumination unit 120 since the light emitting device illumination unit 120 and the adaptor 130 are detachably installed. Further, the illumination apparatus according to FIGS. 1-2 has an adaptor 130 that can recognize the type of the light emitting device illumination unit 120 and thus, adaptively control the light emitting device illumination unit 120. Therefore, the illumination apparatus according to FIGS. 8-9 can be used to freely select a light emitting device illumination unit 120 from among various models manufactured by various manufacturers.

Also, the illumination apparatus according to FIGS. 8-9 includes a display unit 137 and a key input unit 139, so that the user can directly control the light emitting device illumination unit 120.

Referring to FIG. 10, the adaptor 130 may include an AC-DC converter 134, a regulator 135, a light emitting device driver 136, a controller 138, a key input unit 139, and a display unit 137. The light emitting device illumination unit 120 may include a light emitting device unit 126 and a lamp information generator 127.

Describing in more detail, the power supply unit that supplies power in the adaptor 130 includes the AC-DC converter 134 and the regulator 135. The AC-DC converter 134 converts the AC power supplied through the sockets 11 and 12 into DC power, and the regulator 135 can output the DC power from the AC-DC converter 134 at a predetermined DC voltage. For example, as shown in FIG. 5, the AC-DC converter 134 and the regulator 135 may comprise a bridge rectifying circuit 34a and a smoothing circuit (or filter) 35a.

The light emitting device driver 136 outputs the DC voltage from the regulator 135 as a driving power suitable to drive a plurality of light emitting devices 121. In one embodiment, the driving power comprises one or more pulses.

The light emitting device driver 136 may include a first light emitting device driver, a second light emitting device driver, a third light emitting device driver, and a fourth light emitting device driver (e.g., as shown in FIG. 6). Each of the first light emitting device driver, the second light emitting device driver, the third light emitting device driver, and the fourth light emitting device driver can respectively drive a first light emitting string, a second light emitting device driver, a third light emitting device string, and a fourth light emitting device string on the light emitting device illumination unit 120. The operation of the light emitting device driver 136 is substantially the same as the light emitting device driver 36 according to the embodiment(s) of FIGS. 1-2, and therefore, the description thereof will not be repeated.

The controller 138 controls the light emitting device driver(s) (e.g., the first light emitting device driver, the second light emitting device driver, the third light emitting device driver, and the fourth light emitting device driver) to drive the light emitting device(s) (e.g., the first light emitting device string, the second light emitting device string, the third light emitting device string, and the fourth light emitting device string). For example, the controller 138 may provide different driving pulse information to the various light emitting device drivers, thereby making it possible to vary or change the color, brightness, saturation, flickering, etc., of light emitted from the plurality of light emitting devices 121.

Meanwhile, the light emitting device illumination unit 120 may include a lamp information generator 127. The lamp information generator 127 provides information on the light emitting device illumination unit 120 (or components thereof) to the controller 138. The lamp information generator 127 can provide the information to the controller 138 by an electrical and/or mechanical method. The lamp information generator 127 can comprise a chip (e.g., chip 27a as shown in FIG. 7).

The information on the light emitting device illumination unit 120 may include, for example, at least one of the size of the substrate 123, the type and number of the light emitting devices 121 installed on the substrate 123, the brightness and color information of light emitted from the light emitting device illumination unit 120 and/or from one or more light emitting devices 121, and power information that includes the voltage and current suitable to drive the light emitting device illumination unit 120 and/or one or more light emitting devices 121 or light emitting device strings.

The lamp information generator 127 receives a DC voltage from the adaptor 130 and supplies the information regarding the lamp and/or components thereof to the controller 138 of the adaptor 130. The controller 138 receives the lamp information, thereby making it possible to adaptively drive the light emitting device illumination unit 120 according to the lamp information.

For example, the controller 138 may provide control signals to the light emitting device driver(s) 136 so that suitable and/or predetermined voltages and/or currents for the light emitting device illumination unit 120 are provided according to the power information in the lamp information generator 127. In addition, the controller 138 may supply control signals to the light emitting device driver(s) 136 so that suitable driving signals are provided to the light emitting device illumination unit 120 to emit the desired brightness and color according to the brightness and color information of the light emitted from the light emitting device illumination unit 120.

The key input unit 139 and the display unit 137 provides an interface that enables the user to directly control the light emitting device illumination unit 120. The user can operate the individual controls of the key input unit 139 to control the brightness and color of light emitted from the light emitting device illumination unit 120, set the timer function that turns on and off the light emitting device illumination unit 120 at a predetermined time or after a predetermined amount of time, and select the operational mode of the light emitting device illumination unit 20.

The display unit 137 displays the key input state, the current settings, a selectable menu and/or submenu, etc., to the user, so that the user can easily control the light emitting device illumination unit 120. For example, the user can input a command, instruction and/or intensity setting on the brightness control unit (e.g., button, knob, key, touchpad, etc.), making it possible to increase or reduce the brightness of light emitted from the light emitting device illumination unit 120. Moreover, the user can input a color selection on the color control unit (e.g., button, knob, key, touchpad, etc.), so that light emitted from the light emitting device illumination unit 120 can have one or more of a variety of colors. Further, the user can input a timing selection or an on-off cycle selection using the timer function unit (e.g., button), so that the light emitting device illumination unit 120 can be turned on or turned off at one or more specific times. Further, the user can input a command, instruction and/or environment setting on the operational mode button, such that light emitted from the light emitting device illumination unit 120 has a predetermined specific color, brightness and/or timing pattern (which can change over time), making it possible to control the pattern of light emitted from the light emitting device illumination unit 120 (e.g., mood lighting, strobe lighting, light patterns displayed on a surface, etc.).

Therefore, the user transmits control commands to the controller 138 through the key input unit 139 with feedback from the display unit 137, making it possible to control the light emitting device illumination unit 120. For example, the user can control the light emitting device illumination unit 120 to emit light of a specific color using the key input unit 139, and the controller 138 can control the light emitting device driver(s) 136 to selectively drive the first light emitting device(s) according to the signal input from the key input unit 139.

In addition, the user can turn on or off the light emitting device illumination unit 120 using the key input unit 139 at a predetermined time or after a predetermined amount of time elapses. In other words, the controller 138 can control the light emitting device driver 136 over time by inputting instructions and/or selections using the timer function.

Therefore, the user can transmit the control commands to the controller 138 through the key input unit 139 and the display unit 137, making it possible to control the light emitting device illumination unit 120.

As described above, the illumination apparatus according to FIGS. 8-9 can be also used in existing fluorescent and/or halogen lamp power supply apparatuses that supply AC power to the adaptor 130, which may include the AC-DC converter 134, the regulator 135, and the light emitting device driver 136.

Moreover, the illumination apparatus according to FIGS. 1-2 can obtain information of/from the light emitting device illumination unit 120 in the adaptor 130, making it possible to adaptively control the light emitting device illumination unit 120 according to the characteristics of the light emitting device illumination unit 120 that is connected to the adaptor 130.

Further, the illumination apparatus can include a display unit 37/137 and a key input unit 39/139, so that the user can directly control the light emitting device illumination unit 20/120.

The illumination apparatus may comprise a plurality of LEDs or OLEDs. The illumination apparatus comprising LEDs or OLEDs can be used without replacing existing fluorescent lamp, incandescent lamp, and/or halogen lamp power supply apparatuses. The illumination apparatus can compatibly use various lamps by detachably connecting or installing the adapter and the lamp.

The illumination apparatus can adaptively control the lamp according to the type of the lamp.

The illumination apparatus can allow a user to control the brightness and color of a lamp and select timer functions and the operational mode of the lamp.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is within the purview of one skilled in the art to effect such feature, structure, or characteristic in connection with other embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An illumination apparatus, comprising:
an adaptor that is detachably and electrically connectable to a socket of the illumination apparatus;
a power supply unit at the adapter and that supplies power;
a light emitting device driver that receives power from the power supply unit and that generates driving power;
a controller that controls the light emitting device driver;
an interface that communicates with the controller; and
a light emitting device illumination unit comprising a plurality of light emitting devices that emit light according to the driving power from the light emitting device driver.

2. The illumination apparatus according to claim 1, wherein
the light emitting devices each comprise an LED or an OLED.

3. The illumination apparatus according to claim 1, wherein
the interface includes a key input unit.

4. The illumination apparatus according to claim 3, wherein
the interface further includes a display unit.

5. The illumination apparatus according to claim 4, wherein
the display unit displays one or more of a key input state, a current setting state, and a selectable menu by a user.

6. The illumination apparatus according to claim 3, wherein
the key input unit includes a brightness control unit that increases or reduces the brightness of light emitted from the light emitting device illumination unit.

7. The illumination apparatus according to claim 3, wherein
the key input unit includes a color control unit that changes the color of light emitted from the light emitting device illumination unit.

8. The illumination apparatus according to claim 3, wherein
the key input unit includes a timer function unit that turns the light emitting device illumination unit on or off at a specific or predetermined time.

9. The illumination apparatus according to claim 3, wherein
the key input unit includes an operational mode unit that causes the light emitting device illumination unit to emit light having a predetermined color and specific brightness.

10. The illumination apparatus according to claim 1, wherein
the adaptor and the light emitting device illumination unit are detachably connected to each other.

11. The illumination apparatus according to claim 1, wherein
the socket comprises a fluorescent lamp socket.

12. The illumination apparatus according to claim 11, wherein
the light emitting device illumination unit is connected at one end to the adaptor and is detachably and electrically connected at an opposite end to one of the fluorescent lamp sockets.

13. The illumination apparatus according to claim 1, wherein
the socket comprises an incandescent lamp socket.

14. The illumination apparatus according to claim 1, wherein
the socket comprises a halogen lamp socket.

15. A method of driving an illumination apparatus, comprising:
converting power into driving power in an adapter;
emitting light from a light emitting device illumination unit according to the driving power, the light emitting device illumination unit being detachably and electrically connected to the adapter and including one or more light emitting devices;
inputting a control command through an interface that is connected to the adapter; and
controlling the light emitting device illumination unit according to the control command.

16. The method according to claim 15, wherein
the interface includes a key input unit configured to enable a user to input the control command.

17. The method according to claim 16, wherein
the key input unit includes at least one of a brightness control unit that increases or reduces brightness of light emitted from the light emitting device illumination unit, a color control unit that changes a color of light emitted from the light emitting device illumination unit, a timer function unit that turns the light emitting device illumination unit on or off at a specific or predetermined time, and an operation mode unit that causes the light emitting device illumination unit to emit light having a predetermined color and specific brightness, and
the method includes inputting at least one brightness control command, color control command, timer function command, or operational mode command through the key input unit.

18. The method according to claim 15, wherein
the interface includes a display unit configured to display at least one of a key input state, a current setting state, and a selectable menu to a user.
